(19) United States
(12) Patent Application Publication
(10) Pub. No.: US 2005/0262009 A1
(43) Pub. Date: Nov. 24, 2005

(54) Method and system for bidding in on-line auction

(75) Inventors: Sung-hyu Han, Seoul (KR); Yong-jin Jang, Uiwang-si (KR); Sun-nam Lee, Suwon-si (KR); Sang-su Choi, Buncheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/132,392

(22) Filed: May 19, 2005

(30) Foreign Application Priority Data
May 19, 2004 (KR) 2004-0035533

(51) Int. Cl. G06F 17/60

(52) U.S. Cl. 705/37

(57) ABSTRACT

A bidding method including: (a) generating a first bidding function value using an initial bidding price of a first bidder; (b) transmitting the first bidding function value to a successful bidding decider; (c) transmitting a second bidding function value of a second bidder to the first bidder; (d) transmitting a final bidding price of the first bidder and a final bidding price of the second bidder to the successful bidding decider; (e) determining a successful bidding price by comparing the final bidding price of the first bidder and the final bidding price of the second bidder; and (f) verifying whether or not the successful bidding price was manipulated

### CROSS-REFERENCE TO RELATED APPLICATIONS

This application is based upon and claims the benefit of priority from Korean Patent Application No. 2004-35533, filed on May 19, 2004, in the Korean Intellectual Property Office, the disclosure of which is incorporated herein in its entirety by reference.

### BACKGROUND OF THE INVENTION

1. Field of the Invention

The invention relates to a bidding method, and more particularly, to a bidding method: for preventing a successful bidding decider from manipulating a successful bidding price; and for preventing a bidder's denial of a bidding price, in an on-line auction.

2. Description of the Related Art

Recently, Internet auctions have become popular. The Internet auction is a system where a bidder sends a bidding price to a successful bidding decider, and the successful bidding decider determines bidding qualifications according to a predetermined reference and allocates an auction target object to the bidder that best meets the successful bidding qualifications.

FIG. 1 is a view illustrating a related art bidding method.

A successful bidding decider 10 is provided with bidding prices 22, 32 and 42 from bidders 20, 30 and 40. The successful bidding decider 10 determines the bidding price 12 on the basis of a predetermined successful bidding reference, and transmits the determined bidding price 12 to each of the bidders 20, 30 and 40, thereby terminating an auction procedure.

However, the related art bidding method has the following drawbacks.

First, the successful bidding decider can manipulate the bidding price. Specifically, since the bidders cannot know the bidding prices of the other bidders, the successful bidding decider can fallaciously determine the bidding price to transmit it to the bidders.

Second, the successful bidding decider can analyze all bidding prices to provide a specific conspiring bidder with a bidding price that best meets the successful bidding reference.

Third, a bidder can deny a submitted bidding price.

Fourth, a third party, such as the owner of the object being auctioned, can bid under the disguise of one of the bidders in an attempt to drive up the successful bidding price.

### BRIEF SUMMARY OF THE INVENTION

The invention provides a bidding method for preventing a successful bidding decider from manipulating a successful bidding price and for preventing a bidder from denying his/her bidding price.

According to an aspect of the invention, a bidding method includes: (a) generating a first bidding function value using an initial bidding price of a first bidder; (b) transmitting the first bidding function value to a successful bidding decider; (c) transmitting a second bidding function value of a second bidder to the first bidder; (d) transmitting a final bidding price of the first bidder and a final bidding price of the second bidder to the successful bidding decider; (e) determining a successful bidding price by comparing the final bidding price of the first bidder and the final bidding price of the second bidder; and (f) verifying whether or not the successful bidding price was manipulated.

According to another aspect of the invention, a bidding method includes: (a) generating a first bidding function value using an initial bidding price of a first bidder; (b) transmitting the first bidding function value to a successful bidding decider; (c) transmitting a second bidding function value of a second bidder to the first bidder; (d) transmitting a final bidding price of the first bidder and a final bidding price of the second bidder to the successful bidding decider; (e) verifying whether or not the final bidding price of the first bidder corresponds to the initial bidding price of the first bidder; and (f) determining a successful bidding price by comparing the final bidding price of the first bidder and the final bidding price of the second bidder.

According to a further another aspect of the invention, a bidding system includes: a client adapted to generate an initial bidding price of a first bidder and a first bidding function value using the initial bidding price; and a server adapted to: receive the first bidding function value from the client and a second bidding function value from a second client; transmit the first bidding function value and second bidding function value to the client; receive a final bidding price of the first bidder from the client and a final bidding price of a second bidder from the second client; and determine a successful bidding price by comparing the final bidding price of the first bidder and the final bidding price of the second bidder, wherein the initial bidding price of the first bidder cannot be determined from the first bidding function value.

According to a further another aspect of the invention, the methods described above may be implemented in a program stored on a computer recordable recording medium.

### BRIEF DESCRIPTION OF THE DRAWINGS

The above and other objects, features and advantages of the invention will become more apparent by describing in detail exemplary embodiments thereof with reference to the attached drawings in which:

FIG. 1 is a view illustrating a related art bidding method;

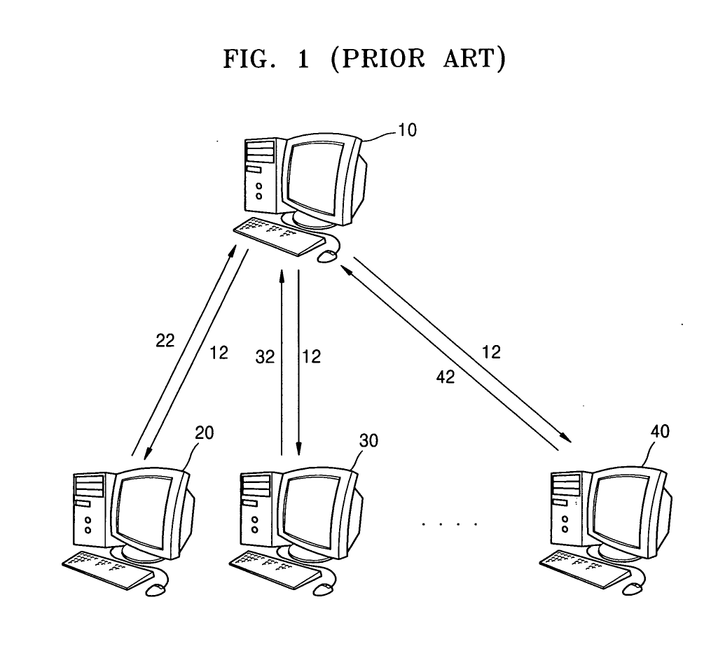

FIG. 2 is a view illustrating a bidding method according to the first exemplary embodiment of the invention;

FIG. 3 is a view illustrating a method of generating a bidding function value;

FIG. 4 is a view illustrating a bidding method according to the second exemplary embodiment of the invention;

FIG. 5 is a view illustrating a bidding method according to the third exemplary embodiment of the invention;

FIG. 6 is a view illustrating a bidding method according to the fourth exemplary embodiment of the invention;

FIG. 7 is a view illustrating a bidding method according to the fifth exemplary embodiment of the invention;

FIG. 8 is a view illustrating a bidding method according to the sixth exemplary embodiment of the invention;

FIG. 9 is a view illustrating a bidding method according to the seventh exemplary embodiment of the invention; and

FIG. 10 is a view illustrating a bidding method according to the eighth exemplary embodiment of the invention.

### DETAILED DESCRIPTION OF THE INVENTION

Exemplary embodiments of the invention will now be described below by reference to the attached drawings. The described exemplary embodiments are intended to assist the understanding of the invention, and are not intended to limit the scope of the invention in any way. Like reference numerals in the drawings denote like elements.

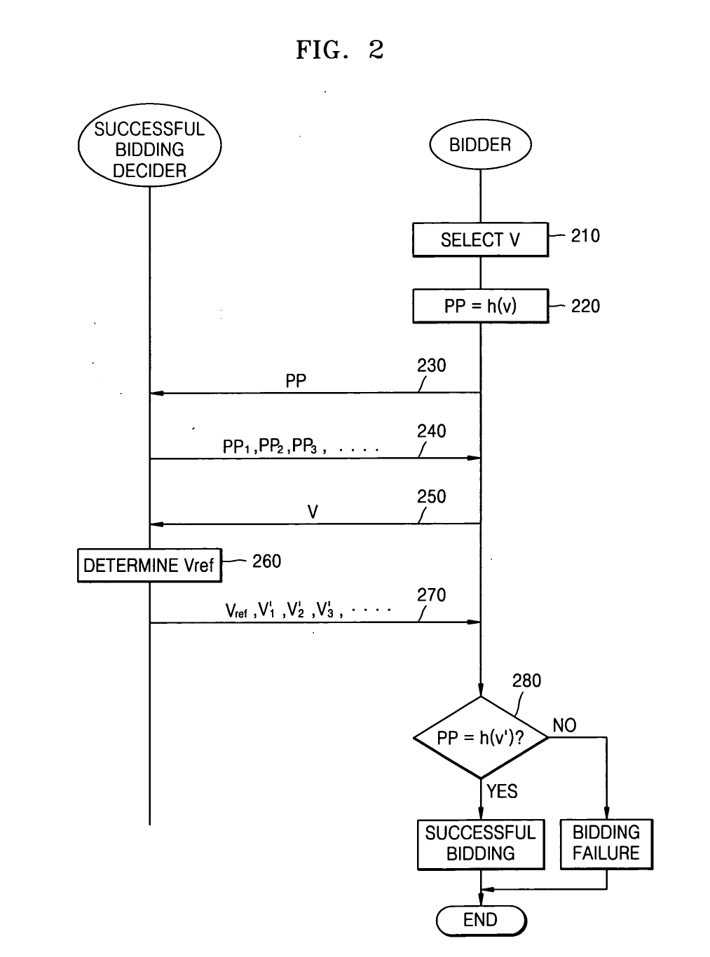

FIG. 2 is a view illustrating a bidding method according to a first exemplary embodiment of the invention.

In operation 210, a client (i.e., a bidder (u₁)) selects his or her bidding price (v₁).

In operation 220, the bidder (u₁) inputs the bidding price (v₁) to a bidding function h(x) to generate a bidding function value (PP₁). The bidding function h(x) should provide the bidding function value from the bidding price, but not provide the bidding price from the bidding function value, for the reasons discussed below.

In operation 230, the bidder (u₁) transmits the generated bidding function value (PP₁) to the successful bidding decider. Additionally, any other bidders (u₂, u₃ . . . ) transmit their respective bidding function values (PP₂, PP₃ . . . ) to the successful bidding decider so that the successful bidding decider has the bidding function values from each of the bidders. When all bidding function values have been transmitted, the transmission of further bidding function values is no longer allowed.

In operation 240, the successful bidding decider transmits all the received bidding function values PP₁, PP₂, PP₃, . . . to each of the bidders. As a result, each bidder knows the bidding function values for the bidding prices made by the other bidders.

In operation 250, all bidders transmit their bidding prices v (v₁, v₂, v₃ . . . ) to the successful bidding decider. Bidders u₁, u₂, u₃ . . . respectively set the bidding prices v₁, v₂, v₃ . . .

In operation 260, the successful bidding decider compares the bidding prices v₁, v₂, v₃ . . . of the bidders u₁, u₂, u₃ . . . with one another to determine the successful bidding price V_{ref}.

In operation 270, the successful bidding decider transmits the determined bidding price V_{ref} and all bidding prices v₁′, v₂′, v₃′ . . . to each of the bidders u₁, u₂, u₃ . . . The transmitted bidding prices v₁′, v₂′, v₃′ . . . refer to bidding prices that the successful bidding decider indicates are transmitted by each of the bidders.

In operation 280, each of the bidders compares the received bidding function values PP₁, PP₂, PP₃, . . . (received in operation 240) with input function values h(v₁′), h(v₂′), h(v₃′) . . . generated by inputting the received bidding prices v₁′, v₂′, v₃′ . . . (received in operation 270) into the bidding function discussed above, to determine whether or not the successful bidding decider fallaciously reported the bidding price to the bidder.

More specifically, if the successful bidding decider attempts to manipulate the bidding (i.e., if each of the bidders does not bid with reference to the bidding price transmitted from each bidder), the bidding function values PP₁, PP₂, PP₃, . . . are not identical to the bidding function values F(v₁′), F(v₂′), F(v₃′) . . . since v₁′ v₁, v₂′ v₂, and/or v₃′ v₃ . . . Only in the case where the bidding function values PP₁, PP₂, PP₃, . . . are identical to the bidding function values F(v₁′), F(v₂′), F(v₃′) is the bidding determined to be successful. Otherwise, the bidding is determined to be a failure and thus the procedure is ended in a state where the bidding method was not in a secured transparency.

In the bidding method of FIG. 2, the bidder u₁ possesses the bidding function values PP₂, PP₃, . . . that may be used to confirm the bidding prices of other bidders u₂, u₃, . . . that were submitted prior to the determination of the successful bidding price. Thus, this bidding method can prevent the successful bidding decider from manipulating the bidding, as described in detail below.

First, since each of the bidders u₁, u₂, u₃ . . . secures the bidding function values PP₁, PP₂, PP₃, . . . that can confirm the bidding prices of other bidders u₁, u₂, u₃. . . before the successful bidding decider determines the successful bidding price, the successful bidding decider cannot determine the successful bidding price using bidding prices different from those transmitted by the bidders u₁, u₂, u₃ . . . Rather, if bidding prices different from those transmitted by the bidders u₁, u₂, u₃ . . . are used, this manipulation is discovered in operation 280.

Second, if all bidding function values PP₁, PP₂, PP₃, . . . are transmitted to the successful bidding decider, the bidding prices v₁, v₂, v₃ . . . of the bidders u₁, u₂, u₃ . . . cannot be substantially changed thereafter.

Third, since the successful bidding decider cannot acknowledge the individual bidding prices v₁, v₂, v₃ . . . of the bidders u₁, u₂, u₃ . . . from the bidding functions PP (since it is impossible to determine the bidding price from the bidding function value), the successful bidding decider can be prevented from informing a specific bidder of the bidding price of other bidders, which is advantageous for competitiveness of the bidding.

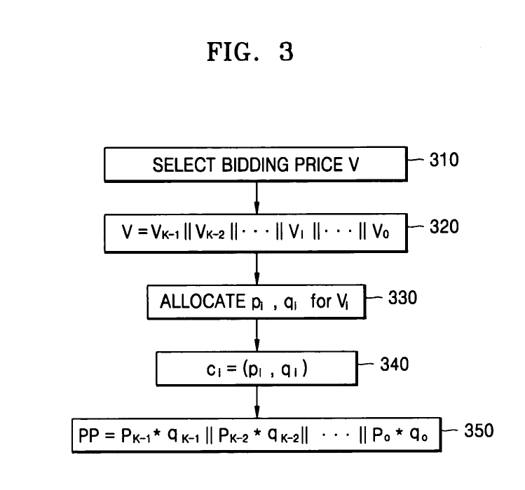

FIG. 3 is a view illustrating an exemplary method of generating the bidding function value. Other methods are also available.

As briefly discussed above, a bidding function (h) generates a bidding function value PP from a bidding price V. That is, PP=h(V).

In operation 310, the bidder selects the bidding price V.

In operation 320, the bidding price is binarized to obtain binary constants V₀, V₁, V₂, . . . , Vₖ₋₂, Vₖ₋₁, which respectively corresponding to digits. The binary constant Vₖ₋₁ corresponds to a Most Significant Bit (MSB) of a binary number, and the binary constant V0 corresponds to a Least Significant Bit (LSB). The binary constant Vᵢ has 0 or 1 due to the binarization.

In operation 330, two predetermined prime numbers are selected for binary constants V₀, V₁, V₂, . . . , Vᵢ, . . . , Vₖ₋₁ according to the following three rules to allocate a first prime number pᵢ and a second prime number qᵢ.

First, if Vᵢ=0, a modular 4 operation of the first prime number has a result value of 1, and a modular 4 operation of the second prime number has a result value of 3.

Second, if Vᵢ=0, the modular 4 operation of the first prime number has a result value of 3, and the modular 4 operation of the second prime number has a result value of 1.

Third, the second prime number is larger than the first prime number.

In operation 340, a pair of the first prime number pᵢ and the second prime number qᵢ is defined as a bidding coefficient Cᵢ.

In operation 350, after the multiplication of the first prime number pᵢ and the second prime number qᵢ, the multiplication result is arranged in a position of the binary constant Vᵢ corresponding to the first prime number pᵢ and the second prime number qᵢ to generate the bidding function value PP.

For example, in case where the bidding price (V) is 5, the binarized bidding price VBᵢₙ is 0101 and accordingly, the binary constants are obtained as V₃=0, V₂=1, V₁=0, V₀=1. According to the aforementioned rules, the first prime number and the second prime number are selected as P₃=5, Q₃=7, Q₂=13, P₁=5, Q₁=7, P₀=7, Q₀=13 for the binary constant. The prime number can be arbitrarily selected within the above three rules. If the selected prime number is multiplied and concatenated, the bidding function value is obtained as PP=5*7//7*13//5*7//7*13=35//91//35//91=00100011//01011011//00100011//01011011. That is, the bidding price (V=5) corresponds to the bidding function value (PP=00100011/01011011//00100011//01011011).

In the method of FIG. 3, the selection and the multiplication of the prime numbers are performed to obtain the bidding coefficient Cᵢ from the bidding price and then obtain the bidding function value from the bidding coefficient Cᵢ. However, it is not easy to obtain the selected prime number from the bidding function value and obtain the bidding price from the selected prime number. For example, if a prime number of over 500 bits is selected, it is difficult to perform the aforementioned inverse calculation process using current calculators.

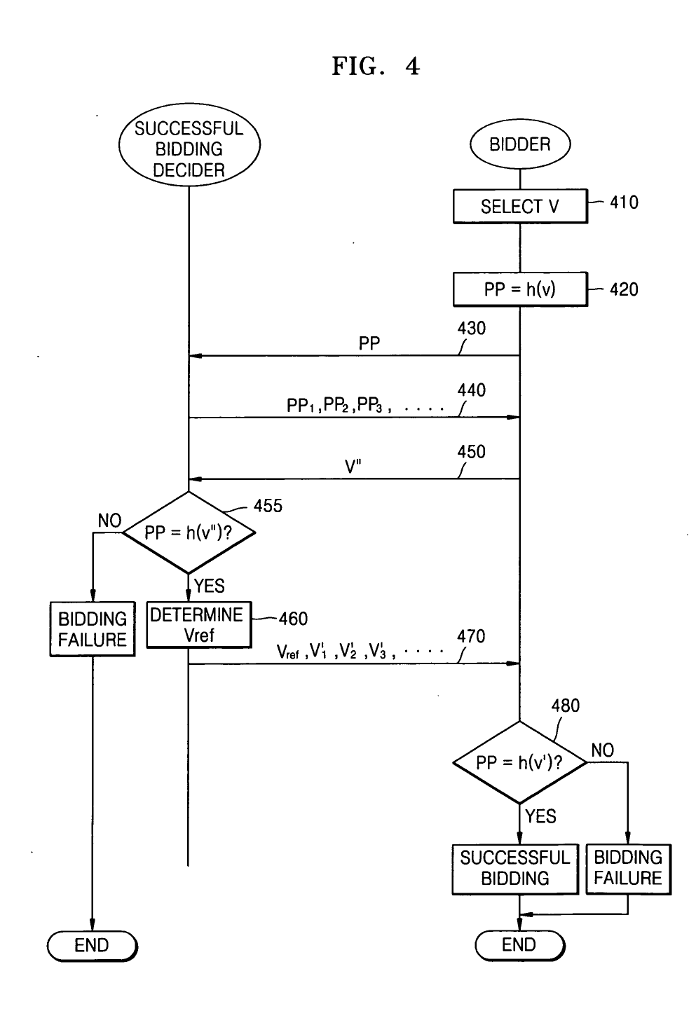

FIG. 4 is a view illustrating a bidding method according to a second exemplary embodiment of the invention.

In operation 410, a client (i.e., a bidder (u₁)) selects his or her bidding price (v₁).

In operation 420, the bidder (u₁) inputs the bidding price (v₁) to a bidding function (h(x)) to generate a bidding function value PP₁.

In operation 430, the bidder (u₁) transmits the generated bidding function value (PP₁) to a successful bidding decider.

In operation 440, the successful bidding decider transmits all of the received bidding function values PP₁, PP₂, PP₃, . . . to each of the bidders.

In operation 450, all bidders transmit their bidding prices v″ (v₁″, v₂″, v₃″ . . . ) to the successful bidding decider. The bidding prices v₁″, v₂″, v₃″ . . . refer to bidding prices that, the bidders u₁, u₂, u₃ . . . claim are made in operation 410. Thus, the bidding price (v) of the embodiment of FIG. 2 is different from the bidding price (v″) of the embodiment of FIG. 4.

In operation 455, the successful bidding decider checks whether or not a bidding function value h(v″) is identical with the bidding function value PP received from the bidder in operation 430. The bidding function value h(v″) is generated by inputting the bidding price (v″) received from the bidder in the operation 450, to the bidding function. That is, it is determined whether or not PP₁ is equal to h(v1″), PP₂ is equal to h(v2″), and PP₃ is equal to h(v3″), . . . If it is determined that PP₁ is equal to h(v1″), PP₂ is equal to h(v2″), and PP₃ is equal to h(v3″) . . . , a next process 460 is performed. Otherwise, the bidding is determined to be a failure and thus the procedure is ended.

In operation 460, the successful bidding decider compares the bidding prices (v) of the bidders with one another to determine the successful bidding price V_{ref}. Since it has necessarily been determined that h(v″)=PP (in operation 455), it follows that v=v″, and the bidding price (v″) can be determined as an actual bidding price. As a result, the bidding price (v″) can be compared to determine the successful bidding price.

In operation 470, the successful bidding decider transmits the determined bidding price V_{ref} and all bidding prices (v₁′, v₂′, v₃′ . . . ) to each of the bidders. The bidding prices (v₁′, v₂′, v₃′ . . . ) refer to bidding prices that the successful bidding decider indicates are transmitted by the bidders.

In operation 480, each of the bidders compares the received bidding function values PP₁, PP₂, PP₃, . . . (received in operation 240) with input function values h(v₁′), h(v₂′), v₃′ . . . , generated by inputting the received bidding prices v₁′, v₂′, v₃′. . . (received in operation 270) to the bidding function discussed above, to determine whether or not the successful bidding decider fallaciously reported the bidding price to the bidder.

According to the embodiment of FIG. 4, the bidder can be prevented from transmitting a bidding price (v″) in operation 450 that is different from the bidding price (v) transmitted in operation 410, to the successful bidding decider. Specifically, the bidder cannot deny his/her transmitting bidding price, because if the bidding price (v″) is different from the bidding price (v), it is determined in operation 455 that PP≠H(v″), and thereby that v≠v″.

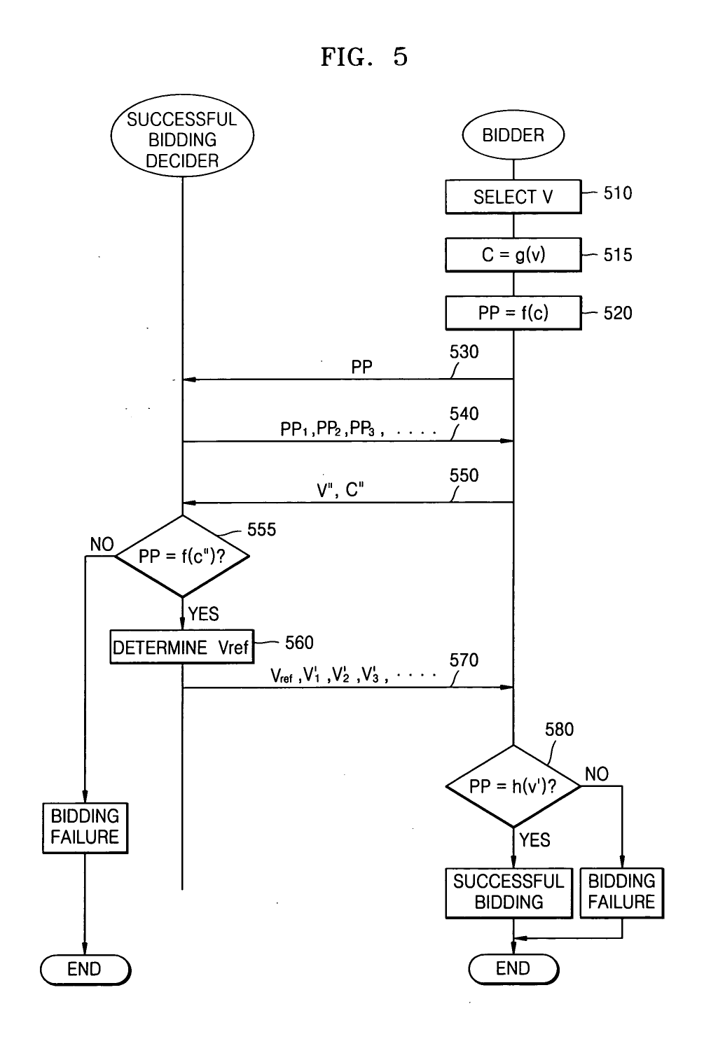

FIG. 5 is a view illustrating a bidding method according to the third exemplary embodiment of the invention.

In operation 510, a client (i.e., a bidder (u₁)) selects his or her bidding price (v₁).

In operation 515, the bidder (u₁) inputs the bidding price (v₁) to a first lowest bidding function g(v) to generate a bidding coefficient (C). The first lowest bidding function g(v) refers to a function of generating the bidding coefficient (C₁) from the bidding price (v), for example, a function comprised of the operations 320 to 340 of FIG. 3. According to the first lowest bidding function g(v), more than one bidding coefficient can be generated for each bidding price.

In operation 520, the bidder (u₁) inputs the bidding coefficient (C) to a second lowest bidding function f(C) to generate the bidding function value PP₁. According to the second lowest bidding function f(C), one bidding function value should be generated for each bidding coefficient. In comparison with FIG. 4, the bidding function, the first lowest bidding function and the second lowest bidding function have a relation of h(v)=f(g(v)).

In operation 530, the bidder (u₁) transmits the generated bidding function value (PP₁) to the successful bidding decider.

In operation 540, the successful bidding decider transmits all of the received bidding function values PP₁, PP₂, PP₃, . . . to each of the bidders.

In operation 550, all of the bidders transmit their bidding prices v″(v₁″, v₂″, v₃″ . . . ) and bidding coefficients C″ (C₁″, C₂″, C₃″ . . . ) to the successful bidding decider. The bidding prices v1″, v2″, v₃″ . . . refer to bidding prices that the bidders u₁, u₂, u₃ . . . claim are made in operation 510, and the bidding coefficients C₁″, C₂″, C₃″ . . . refer to bidding coefficients that the bidders u₂, u₃ . . . . claim are generated in operation 515.

In operation 555, the successful bidding decider checks whether or not a bidding function value f(C″), which is generated by inputting the bidding coefficient C″ received from the bidder in operation 550 to the second lowest bidding function f(C), is identical with the bidding function value PP received from the bidder in operation 530. That is, it is determined whether or not PP₁ is equal to f(C₁″), PP₂ is equal to f(C₂″), and PP₃ is equal to f(C₃″), . . . If it is determined that PP₁ is equal to f(C₁″), PP₂ is equal to f(C₂″), and PP₃ is equal to f(C₃″), . . . a next process 560 is performed. Otherwise, the bidding is determined to be a failure and thus the procedure is ended.

Processes 560 through 580 are similar to operations 460 through 480 of FIG. 4.

In 560, the successful bidding decider compares the bidding prices (v) of the bidders with one another to determine the successful bidding price V_{ref}. Since it has necessarily been determined that f(c″)=PP (in operation 555), it follows that v=v″, and the bidding price (v″) can be determined as an actual bidding price. As a result, the bidding prices (v″) can be compared to determine the successful bidding price.

In operation 570, the successful bidding decider transmits the determined bidding price V_{ref} and all bidding prices (v₁′, v₂′, v₃′ . . . ) to each of the bidders. The bidding prices (v₁′, v₂′, v₃′ . . . ) refer to bidding prices that the successful bidding decider indicates are transmitted by the bidders.

In operation 580, each of the bidders compares the received bidding function values PP₁, PP₂, PP₃, . . . (received in operation 540) with input function values h(v₁′), h(v₂′), v₃′ . . . generated by inputting the received bidding prices (v₁′, v₂′, v₃′ . . . ) (received in operation 570) to the bidding function discussed above, to determine whether or not the successful bidding decider fallaciously reported the bidding price to the bidder.

The embodiment of FIG. 5 is different from that of FIG. 4 in that a bidding coefficient, not a bidding price, is used for checking the original bidding price submitted by the bidder. Specifically, the embodiment of FIG. 5 is different from that of FIG. 4 in that the bidding coefficient, not the bidding price, is used to compare the bidding function value PP with the bidding function value f(C″) in operation 555. The method of FIG. 5 has an advantage in that an operation required in the operation 555 is more simplified.

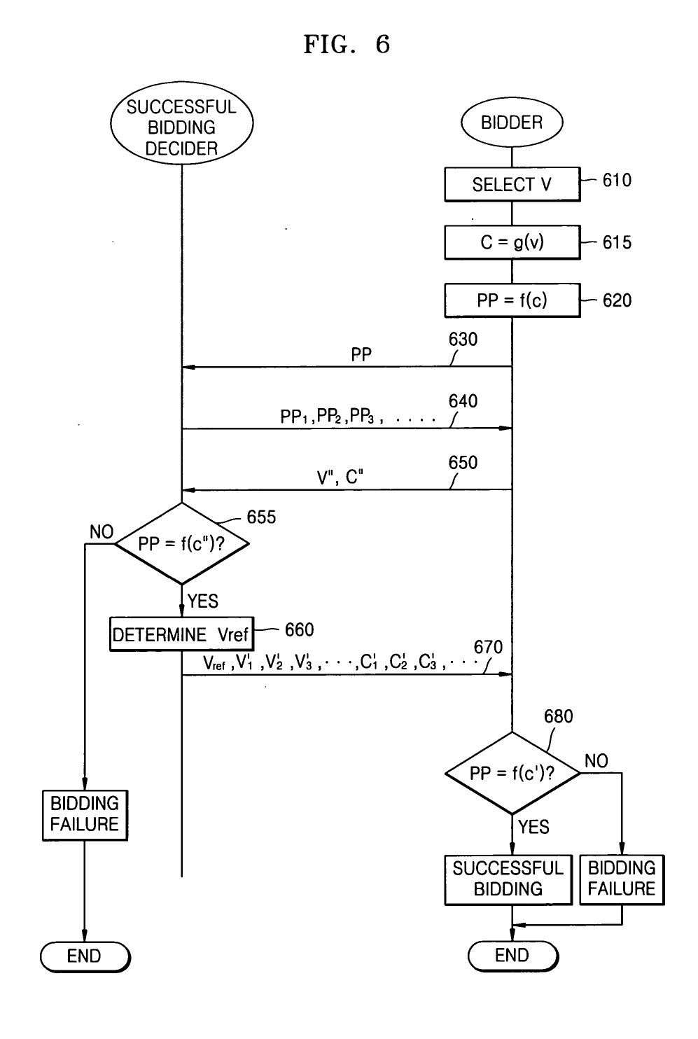

FIG. 6 is a view illustrating a bidding method according to the fourth exemplary embodiment of the invention.

In operation 610, a client (i.e., a bidder (u₁)) selects his or her bidding price (v₁).

In operation 615, the bidder (u₁) inputs the bidding price (v₁) to a first lowest bidding function g(v) to generate a bidding coefficient (C).

In operation 620, the bidder (u₁) inputs the bidding coefficient (C) to a second lowest bidding function f(C) to generate the bidding function value PP₁.

In operation 630, the bidder (u₁) transmits the generated bidding function value (PP₁) to the successful bidding decider.

In operation 640, the successful bidding decider transmits all of the received bidding function values PP₁, PP₂, PP₃, . . . to each of the bidders.

In operation 650, all of the bidders transmit their bidding prices v″ (v₁″, v₂″, v₃″ . . . ) and C″ (C₁″, C₂″, C₃″ . . . ) to the successful bidding decider.

In operation 655, the successful bidding decider determines whether or not a bidding function value f(C″), which is generated by inputting the bidding coefficient C″ received from the bidder in operation 650 to the second lowest bidding function f(C), is identical with the bidding function value PP received from the bidder in operation 630. That is, it is determined whether or not PP₁ is equal to f(C₁″), PP₂ is equal to f(C₂″), and PP₃ is equal to f(C₃″), . . . If it is determined that PP₁ is equal to f(C₁″), PP₂ is equal to f(C₂″), and PP₃ is equal to f(C₃″), . . . a next process 660 is performed. Otherwise, the bidding is determined to be a failure and thus the procedure is ended.

In operation 660, the successful bidding decider compares the bidding prices (v″) of the bidders with one another to determine the successful bidding price V_{ref}. Since it has necessarily been determined that f(c″)=PP (in operation 655) it follows that v=v″, and the bidding price (v″) can be determined as an actual bidding price. As a result, the bidding price (v″) can be compared to determine the successful bidding price.

In operation 670, the successful bidding decider transmits the determined bidding price V_{ref} and all bidding prices (v₁′, v₂′, v₃′ . . . ) to each of the bidders.

In operation 680, each of the bidders compares the received bidding function values PP₁, PP₂, PP₃, . . . (received in operation 640) with input function values f(c₁′), f(c₂′), f(c₃′) . . . generated by inputting the received bidding prices (v₁′, v₂′, v₃′ . . . ) (received in operation 670) to the bidding function discussed above, to determine whether or not the successful bidding decider fallaciously reported the bidding price to the bidder.

The embodiment of FIG. 6 is different from that of FIG. 5 in that a bidding function value PP is compared with the bidding function value f(c′) to determine whether or not any of the bidders manipulated the bidding. The method of FIG. 6 has an advantage in that time taken to determine whether or not the bidding was manipulated is reduced due to the simplification of the operation 680.

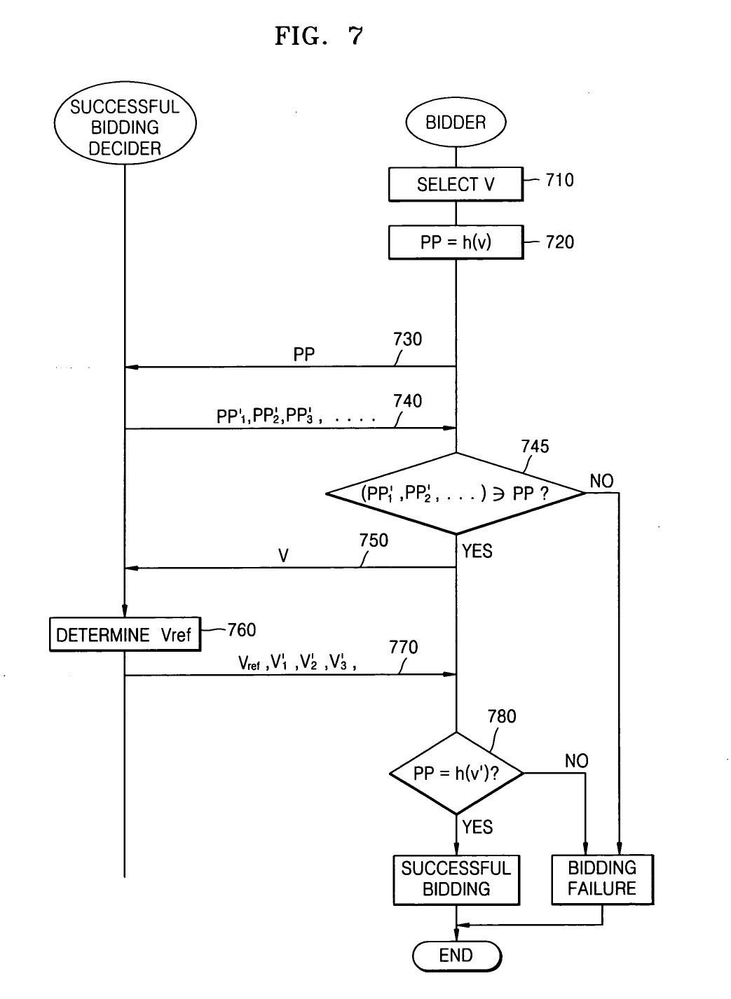

FIG. 7 is a view illustrating a bidding method according to the fifth exemplary embodiment of the invention.

In operation 710, a client, (i.e. a bidder (u₁)) selects his or her bidding price (v₁).

In operation 720, the bidder (u₁) inputs the bidding price (v₁) to a bidding function h(x) to generate a bidding function value PP₁.

In operation 730, the bidder (u₁) transmits the generated bidding function value (PP₁) to the successful bidding decider.

In operation 740, the successful bidding decider transmits bidding function values PP₁′, PP₂′, PP₃′, . . . to each of the bidders, which, the successful bidding decider indicates are received from each of the bidders.

In operation 745, all of the bidders determine whether or not the bidding function values PP₁′, PP₂′, PP₃′, . . . include the bidding function values PP₁, PP₂, PP₃, . . . , which the bidder has transmitted to the successful bidding decider in operation 730. That is, the bidder (u₁) checks whether or not a relation of (PP₁′, PP₂′, PP₃′, . . . ) [symbol] PP₁ is satisfied, the bidder (u₂) checks whether or not a relation of (PP₁′, PP₂′, PP₃′, . . . ) [symbol] PP₂ is satisfied, and the bidder (uₖ) checks whether or not a relation of (PP₁′, PP₂′, PP₃′, . . . ) [symbol] P_{Pk} is satisfied. If it is determined that the bidding function values PP₁′, PP₂′, PP₃′, . . . include the bidding function values PP₁, PP₂, PP₃, . . . , a next process 750 is performed. Otherwise, the bidding is determined to be a failure, and is ended.

The next processes are the same as those of the embodiment shown in FIG. 2.

In operation 750, all of the bidders transmit their bidding prices v (v₁, v₂, v₃ . . . ) to the successful bidding decider.

In operation 760, the successful bidding decider compares the bidding prices of the bidders to determine the bidding price V_{ref}.

In operation 770, the successful bidding decider transmits the determined bidding price V_{ref} and all bidding prices v₁′, v₂′, v₃′ . . . to each of the bidders u₁, u₂, u₃ . . .

In operation 780, each of the bidders compares the received bidding function values PP₁, PP₂, PP₃, . . . (received in operation 740) with input function values h(v₁′), h(v₂′), h(v₃′) . . . , which are generated by inputting the received bidding prices v₁′, v₂′, v₃′ . . . (received in operation 770) to the bidding function discussed above, to determine whether or not the successful bidding decider fallaciously reported the bidding price to the bidder.

The method of FIG. 7 is different from the method of FIG. 2 in that the operation 745 is further performed.

Specifically, in the exemplary method of FIG. 2, bidders cannot recognize that the successful bidding decider transmits manipulated bidding function values PP₁′, PP₂′, PP₃′, . . . to the bidder in operation 740. As a result, if the successful bidding decider transmits the manipulated bidding prices PP₁′, PP₂′, PP₃′, . . . , instead of the actual bidding prices PP₁, PP₂, PP₃, . . . , to the bidder, the determination of whether or not the bidding is manipulated (operation 780) can be no longer relied upon.

However, according to the method of FIG. 7, since all of the bidders determine whether or not the bidding function values are authentic, it is impossible for manipulated bidding function values to be transmitted to the bidders in operation 750. In other words, according to the embodiment of FIG. 7, the successful bidding decider is prevented from transmitting the manipulated bidding function value to the bidder, thereby increasing the reliability of the results of the operation 780 for preventing manipulation of the bidding price.

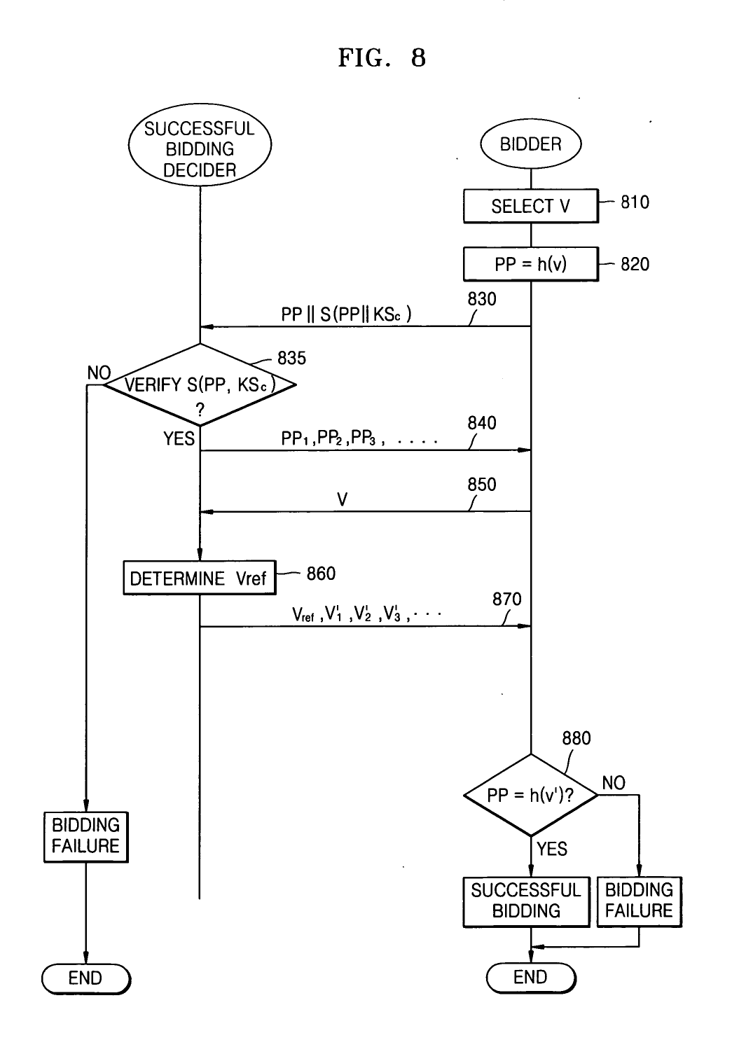

FIG. 8 is a view illustrating a bidding method according to the sixth exemplary embodiment of the invention.

In operation 810, a client (i.e. , a bidder (u₁)) selects his or her bidding price (v₁).

In operation 820, the bidder (u₁) inputs the bidding price (v₁) to a bidding function h(x) to establish a bidding function value PP₁.

In operation 830, the bidder uses his or her secret key K_{Sc} to perform a digital signature, and then transmits the digital-signature bidding function value PP//S(PP, K_{Sc}) to the successful bidding decider.

In operation 835, the successful bidding decider uses a public key K_{Pc} of the bidder to verify the received digital-signature bidding function value PP//S(PP, K_{Sc}). The successful bidding decider has already possessed the public key K_{Pc} of the bidder through a certification organization. The digital signature is widely known, and a description thereof is omitted. If the signature is verified in operation 835, it is secured that a current successful bidding decider receives the bidding function value PP from a currently signing bidder (u₁).

The operations 840 through 880 are similar to the operations 240 through 280 of FIG. 2.

According to the method of FIG. 8, the bidder (u₁) cannot deny that the bidder (u₁) transmits the bidding function value PP to the successful bidding decider in operation 830.

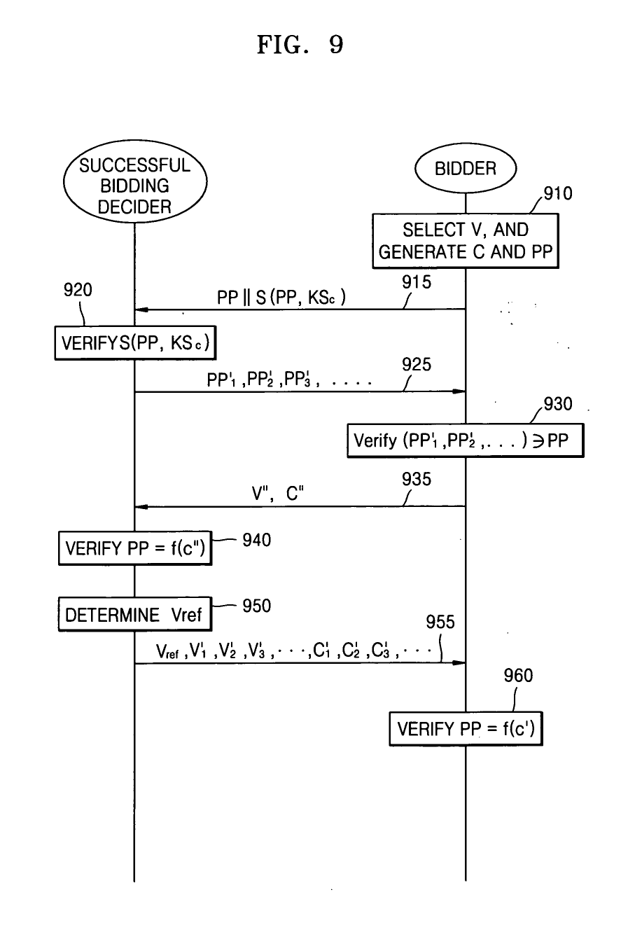

FIG. 9 is a view illustrating a bidding method according to the seventh exemplary embodiment of the invention.

Each of the embodiments shown in FIGS. 2 through 8 can be combined with one another. As an example, the embodiment of FIG. 9 represents one of the combined embodiments of FIGS. 2 through 8.

In operation 910, a client (i.e. a bidder (u₁)) selects his or her bidding price (v₁), and inputs the bidding price (v₁) to a bidding function h(x) to establish a bidding function value PP₁. The bidding function h(x) has a relation of h(x)=f(g(v)) as shown in FIG. 5.

In operation 915, the bidder uses the secret key K_{Sc} to apply his or her digital signature to the bidding function value PP, and then transmits the digital-signature bidding function value PP//S(PP, K_{Sc}) to the successful bidding decider.

In operation 920, the successful bidding decider uses the public key K_{Pc} of the bidder to verify the received digital-signature bidding function value PP//S(PP, K_{Sc}). If so, it is secured that a current successful bidding decider receives the bidding function value PP from a current signing bidder (u₁).

In operation 925, the successful bidding decider transmits bidding function values PP₁′, PP₂′, PP₃′, . . . that the successful bidding decider indicates are received from each of the bidders, to each of the bidders.

In operation 930, all of the bidders receive the bidding function values PP₁′, PP₂′, PP₃′, . . . any verify whether or not the bidding function values PP₁, PP₂′, PP₃′, . . . include the bidding function values PP₁, PP₂, PP₃, . . . which the bidder has transmitted to the successful bidding decider in operation 915. If it is determined that the bidding function values PP₁′, PP₂′, PP₃′, . . . include the bidding function values PP₁, PP₂, PP₃, . . . , it is confirmed that the successful bidding decider is not transmitting manipulated bidding function values to the bidders.

In operation 935, all bidders transmit their bidding prices v″ (v1″, v2″, . . . ) and C″ (C1′, C2″, . . . ) to the successful bidding decider.

In operation 940, the successful bidding decider verifies whether or not the bidding function value f(C″), which is generated by inputting the bidding coefficient C″ received from the bidder in operation 935 to the second lowest bidding function f(C), is identical with the bidding function value PP received from the bidder in the operation 915. That is, it is determined whether or not PP₁ is equal to f(C1″), PP₂ is equal to f(C2″), and PP₃ is equal to f(C3″), . . . Thus, the bidder can be prevented from transmitting a bidding price (v″) different from the original bidding price (v) of the operation 910 to the successful bidding decider. That is, the bidder cannot change his or her originally transmitted bidding price.

In operation 950, the successful bidding decider compares the bidding prices of the bidders to determine the bidding price V_{ref}.

In operation 955, the successful bidding decider transmits the determined bidding price V_{ref} and all bidding prices c₁′, c₂′, c₃ ′ . . . to each of the bidders.

In operation 960, each of the bidders compares the received bidding function values PP₁, PP₂, PP₃, . . . from operation 925 with the input function values f(c₁′), f(c₂′), f(c₃′) . . . , which are generated by inputting the received bidding coefficients c₁′, c₂′, c₃′ . . . of the operation 955 to the second lowest bidding function f(C), to verify whether or not the successful bidding decider fallaciously reported the bidding price to the bidder. That is, in operation 960, it is verified whether or not the successful bidding decider manipulated the bidding price.

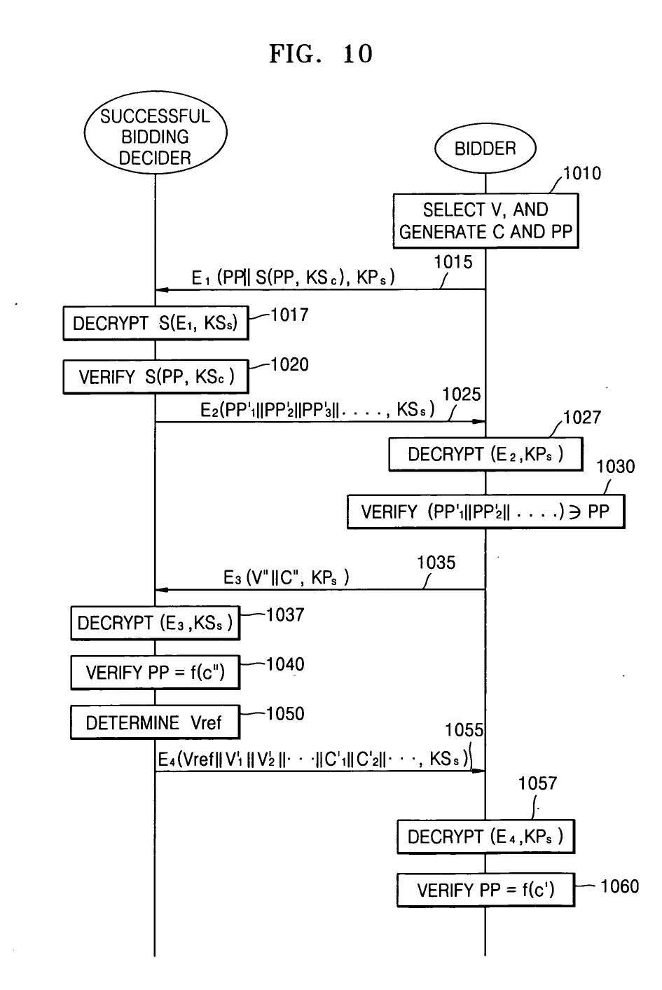

FIG. 10 is a view illustrating a bidding method according to the eighth exemplary embodiment of the invention.

In the ninth exemplary embodiment, since data transmissions between a successful bidding decider and a bidder in the other exemplary embodiments are not all in an encrypted state, it is possible that a third party could copy the transmitted data. In order to overcome this drawback, a message may be transmitted between the bidder and the successful bidding decider in an encrypted state, as shown in FIG. 10.

For message encryption and decryption, a public key infrastructure is used. According to a concept of the public key infrastructure, the successful bidding decider possesses a public key K_{Pc} of the bidder, and the bidder possesses the public key K_{Ps} of the successful bidding decider.

In operation 1010, the bidder (u₁) selects his or her bidding price (v₁), and establishes the bidding function value PP₁.

In operation 1015, the bidder uses the secret key K_{Sc} of the bidder to add his or her digital signature to the bidding function value PP, and then establishes the digital-signature bidding function value PP//S(PP, K_{Sc}), and then encrypts the generated bidding function value PP//S(PP, K_{Sc}) by using the public key K_{Ps} of the successful bidding decider. Finally, the bidder transmits the encrypted bidding function value PP//S(PP, K_{Sc}) to the successful bidding decider.

In operation 1017, the successful bidding decider decrypts the encrypted bidding function value E₁ by using the secret key of the successful bidding decider to generate the digital signed bidding function value PP//S(PP, K_{Sc}).

In operation 1020, the digital signed bidding function value PP//S(PP, K_{Sc}) established in the operation 1017 is verified using the public key K_{Pc} of the bidder.

In operation 1025, the successful bidding decider transmits the bidding function values PP₁′, PP₂′, PP₃′, . . . to each of the bidders by using the secret key K_{Sc} of the successful bidding decider.

In operation 1027, the bidder decrypts the transmitted encrypted bidding function value E₂ by using the public key of the successful bidding decider to establish the bidding function values PP₁′, PP₂′, PP₃′, . . .

In operation 1030, the bidder verifies whether or not the bidding function values PP₁′, PP₂′, PP₃′, . . . include the bidding function values PP₁, PP₂, PP₃, . . . , which the bidder has previously transmitted to the successful bidding decider in operation 1015.

In operation 1035, all of the bidders encrypt their bidding prices v″(v₁″, v₂″, v₃″ . . . ) and the bidding coefficients C″ (C₁″, C₂″, C₃″. . . ) by using the public key K_{Ps} of the successful bidding decider, and then transmit the encrypted bidding prices v″ (v₁″, v₂″, v₃″ . . . ) and the bidding coefficients C″ (C₁″, C₂″, C₃″ . . . ) to the successful bidding decider.

In operation 1037, the successful bidding decider decrypts the encrypted and transmitted bidding price and bidding coefficient E₃ by using the secret key K_{Ss} of the successful bidding decider to establish the bidding price (v″) and the bidding coefficient (c″).

In operation 1040, the successful bidding decider verifies whether or not the bidding function value f(C″), which is established by inputting the bidding coefficient C″ to the second lowest bidding function f(C), is identical with the bidding function value PP received from the bidder in operation 1015.

In operation 1050, the successful bidding decider compares the bidding prices of the bidders with each other to determine the successful bidding price V_{ref}.

In operation 1055, the successful bidding decider uses the secret key K_{Ss} of the successful bidding decider to encrypt, and then transmits the successful bidding price V_{ref}, all bidding prices v₁′, v₂′, v₃′ . . . , and the bidding coefficients c₁′, c₂′, c₃′ . . . to each of the bidders.

In operation 1057, the bidder uses the public key K_{Ps} of the successful bidding decider to decrypt the encrypted and transmitted successful bidding price V_{ref}, all bidding prices v₁′, v₂′, v₃′, . . . , and the bidding coefficients c₁′, c₂′, C₃′ . . .

In operation 1060, the bidder compares the received bidding function values PP₁, PP₂, PP₃, . . . of the operation 1025 with the input function values f(c₁′), f(c₂′), f(c₃′) . . . which are generated by inputting the decrypted bidding coefficients c₁′, c₂′, c₃′ . . . of operation 1057 to the second lowest bidding function f(C), to verity whether or not the successful bidding decider fallaciously reported the bidding price to the bidder. That is, in operation 1060, it is verified whether or not the successful bidding decider manipulated the bidding price.

The embodiment of FIG. 10 is different from the embodiment of FIG. 9 in that the data transmission of the operation 1015, the operation 1025, the operation 1035 and the operation 1055 are performed at the encrypted state and in that the successful bidding decider receiving data through the operation 1015, the operation 1025, the operation 1035 and the operation 1055 decrypts the encrypted data.

The encryption of the operations 1015 and 1035 is performed using the public key K_{Ps} of the successful bidding decider, and the successful bidding decider being at a receiving side uses the secret key K_{Ss} of the successful bidding decider to decrypt the received data. The above process has an effect (message certification effect) of securing that the third party does not copy data. This is because anyone can obtain the public key of the successful bidding decider, but only the successful bidding decider has the secret key of the successful bidding decider.

The encryption of the operations 1025 and 1055 is performed using the secret key K_{Ss} of the successful bidding decider, and the bidder being at the receiving side decrypts the received data by using the public key K_{Ps} of the successful bidding decider.

The embodiments of the invention can be written as computer programs and can be implemented in general-use computers that execute the programs using a computer-readable recording medium. Examples of the computer readable recording medium include magnetic storage media (e.g. , ROM, floppy disks, hard disks, etc.), optical recording media (e.g., CD-ROM or DVDs), and storage media such as carrier waves (e.g. , transmission through the Internet).

As described above, the invention can preliminarily transmit the bidding function value, which can distinguish the bidding prices of all other bidders, to each bidder through the successful bidding decider, thereby preventing the successful bidding decider from manipulating the bidding price.

Further, the invention uses the bidding function value to verify whether or not the bidding price of the bidder is true, thereby preventing the bidder from denying his/her transmitting bidding price.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the invention.

1. A bidding method comprising:
(a) generating a first bidding function value using an initial bidding price of a first bidder;
(b) transmitting the first bidding function value to a successful bidding decider;
(c) transmitting a second bidding function value of a second bidder to the first bidder;
(d) transmitting a final bidding price of the first bidder and a final bidding price of the second bidder to the successful bidding decider;
(e) determining a successful bidding price by comparing the final bidding price of the first bidder and the final bidding price of the second bidder; and
(f) verifying whether or not the successful bidding price was manipulated

2. The method of claim 1, wherein in (f), the verifying is accomplished based upon a comparison of the first bidding function value and the final bidding price of the first bidder, and a comparison of the second bidding function value and the final bidding price of the second bidder.

3. The method of claim 1, wherein the initial bidding price of the first bidder cannot be determined from the first bidding function value.

4. The bidding method of claim 1, wherein the initial bidding price of the first bidder and the final bidding price of the first bidder are the same.

5. The bidding method of claim 1, wherein the final bidding price of the first bidder is claimed by the first bidder to be the same as the initial bidding price of the first bidder.

6. The bidding method of claim 1, wherein the second bidding function value is generated using an initial bidding price of the second bidder.

7. The bidding method of claim 1, further comprising transmitting the successful bidding price and an unsuccessful bidding price to the first bidder and the second bidder.

8. The bidding method of claim 1, wherein (a) comprises:
inputting the initial bidding price of the first bidder to a first lowest bidding function to generate an initial bidding coefficient of the first bidder; and
inputting the initial bidding coefficient of the first bidder to a second lowest bidding function to generate the first bidding function value.

9. The bidding method of claim 8, wherein a final bidding coefficient of the first bidder and a final bidding coefficient of the second bidder are also transmitted in (d).

10. The bidding method of claim 9, wherein the final bidding coefficient of the first bidder is claimed by the first bidder to be the same as the initial bidding coefficient of the first bidder.

11. The bidding method of claim 10, wherein the successful bidding decider compares the first bidding function value to a successful bidding decider function value generated by inputting the final bidding coefficient of the first bidder transmitted in (d) into the second lowest bidding function.

12. The bidding method of claim 1, further comprising:
transmitting the first bidding function value to the first bidder along with the second bidding function in (c); and
checking that a value of the first bidding function value transmitted in (c) matches a value of the first bidding function value transmitted in (b).

13. The method of claim 1, wherein (a) comprises:
binarizing the initial bidding price of the first bidder to generate a binary number;
allocating a predetermined prime number at each digit of the binary number to generate at least one bidding coefficient; and
generating the bidding function value by using the bidding coefficient.

14. The method of claim 13, wherein the prime number is allocated to the binary number according to a result value of a modular operation of the prime number.

15. The method of claim 13, wherein allocating the prime number comprises:
in a case where each digit number of the binary number is 0, generating a prime number having 1 as a remainder of a modular 4 operation among prime numbers as a first bidding coefficient; and
in a case where each digit number of the binary number is 1, generating a prime number having 3 as a remainder of a modular 4 operation among prime numbers as a second bidding coefficient,
wherein the second bidding coefficient is larger than the first bidding coefficient.

16. The method of claim 1, wherein (f) comprises:
generating a first checking bidding function using the final bidding price of the first bidder transmitted in (d);
generating a second checking bidding function using the final bidding price of the second bidder transmitted in (d); and
comparing the first checking bidding function and the second checking bidding function to the first bidding function value and second bidding function value, respectively.

17. The method of claim 16, wherein the generating the first checking bidding function comprises:
binarizing the final bidding price of the first bidder to generate a binary number;
selecting a prime number, by one, at each digit of the binary number to generate at least one bidding coefficient; and
generating the bidding function value by using the bidding coefficient.

18. The method of claim 17, wherein, when selecting the prime number, the prime number is allocated correspondingly to the binary number based on a result value of a modular operation of the prime number.

19. The method of claim 17, wherein, when selecting the prime number:
in a case where each digit number of the binary number is 0, generating a prime number having 1 as a remainder of a modular 4 operation among prime numbers as a first bidding coefficient; and
in a case where each digit number of the binary number is 1, generating a prime number having 3 as a remainder of a modular 4 operation among prime numbers as a second bidding coefficient,
wherein the second bidding coefficient is larger than the first bidding coefficient.

20. The method of claim 1, wherein the final bidding price of the first bidder and the first bidding function value are encrypted using a public key infrastructure (PKI) for transmission.

21. A bidding method comprising:
(a) generating a first bidding function value using an initial bidding price of a first bidder;
(b) transmitting the first bidding function value to a successful bidding decider;
(c) transmitting a second bidding function value of a second bidder to the first bidder;
(d) transmitting a final bidding price of the first bidder and a final bidding price of the second bidder to the successful bidding decider;
(e) verifying whether or not the final bidding price of the first bidder corresponds to the initial bidding price of the first bidder; and
(f) determining a successful bidding price by comparing the final bidding price of the first bidder and the final bidding price of the second bidder.

22. The bidding method of claim 21, wherein in (d), the verifying is accomplished by generating a successful bidding decider function value using the final bidding price of the first bidder and comparing it to the first bidding function value transmitted in (b).

23. The bidding method of claim 21, wherein the second bidding function value is generated using an initial bidding price of the second bidder.

24. The bidding method of claim 21, further comprising transmitting the successful bidding price and an unsuccessful bidding price to the first bidder and the second bidder.

25. The method of claim 21, wherein (a) comprises:
binarizing the initial bidding price of the first bidder to generate a binary number;
allocating a predetermined prime number at each digit of the binary number to generate at least one first bidding coefficient; and
generating the bidding function value by using the first bidding coefficient.

26. The method of claim 25, wherein the prime number is allocated to the binary number according to a result value of a modular operation of the prime number.

27. The method of claim 25, wherein the allocating the prime number comprises:
in a case where each digit number of the binary number is 0, generating a prime number having 1 as a remainder of a modular 4 operation among prime numbers as a first bidding coefficient; and
in a case where each digit number of the binary number is 1, generating a prime number having 3 as a remainder of a modular 4 operation among prime numbers as a second bidding coefficient, and
wherein the second bidding coefficient is larger than the first bidding coefficient.

28. The method of claim 25, wherein:
(c) further comprises transmitting the first bidding coefficient to the successful bidding decider, and
(d) further comprises verifying whether or not the final bidding price of the first bidder corresponds to the initial bidding price of the first bidder by using the first bidding function value transmitted in (a) and a successful bidding decider function value generated by using the first bidding coefficient transmitted in (c).

29. The method of claim 21, wherein the final bidding price of the first bidder and the first bidding function value are encrypted using a public key infrastructure (PKI) for transmission.

30. A bidding system comprising:
a client adapted to generate an initial bidding price of a first bidder and a first bidding function value using the initial bidding price; and
a server adapted to: receive the first bidding function value from the client and a second bidding function value from a second client; transmit the first bidding function value and second bidding function value to the client; receive a final bidding price of the first bidder from the client and a final bidding price of a second bidder from the second client; and determine a successful bidding price by comparing the final bidding price of the first bidder and the final bidding price of the second bidder,
wherein the initial bidding price of the first bidder cannot be determined from the first bidding function value.

31. The system of claim 30, wherein the client verifies whether or not the successful bidding price was manipulated based upon a comparison of the first bidding function value and the final bidding price of the first bidder, and a comparison of the second bidding function value and the final bidding price of the second bidder.

32. The bidding system of claim 30, wherein the initial bidding price of the first bidder and the final bidding price of the first bidder are the same.

33. The bidding system of claim 30, wherein the final bidding price of the first bidder is claimed by the first bidder to be the same as the initial bidding price of the first bidder.

34. The bidding system of claim 30, wherein the second bidding function value is generated using an initial bidding price of the second bidder.

35. The bidding system of claim 30, wherein the server is also adapted to transmit the successful bidding price and an unsuccessful bidding price to the first bidder and the second bidder.

36. The bidding system of claim 30, wherein the client generates the first bidding function value by: inputting the initial bidding price of the first bidder to a first lowest bidding function to generate an initial bidding coefficient of the first bidder; and inputting the initial bidding coefficient of the first bidder to a second lowest bidding function to generate the first bidding function value.

37. The bidding system of claim 36, wherein the server is also adapted to receive a final bidding coefficient of the first bidder and a final bidding coefficient of the second bidder.

38. The bidding system of claim 37, wherein the final bidding coefficient of the first bidder is claimed by the first bidder to be the same as the initial bidding coefficient of the first bidder.

39. The bidding system of claim 38, wherein the server compares the first bidding function value to a server function value generated by inputting the final bidding coefficient of the first bidder into the second lowest bidding function.

40. The bidding system of claim 30, wherein:
the server is also adapted to transmit the first bidding function value to the first bidder along with the second bidding function; and
the client is also adapted to check that a value of the first bidding function value received from the server matches a value of the first bidding function value previously transmitted to the server.

41. The system of claim 30, wherein the client is also adapted to:
binarize the initial bidding price of the first bidder to generate a binary number;
allocate a predetermined prime number at each digit of the binary number to generate at least one bidding coefficient; and
generate the bidding function value on the basis of the bidding coefficient.

42. The system of claim 41, wherein the client is also adapted to generate the bidding coefficient by allocating the prime number to the binary number according to a result value of a modular operation of the prime number.

43. The system of claim 41, wherein the client is also adapted to:
generate a prime number having 1 as a remainder of a modular 4 operation among prime numbers as a first bidding coefficient in case where each digit number of the binary number is 0; and
generate a prime number having 3 as a remainder of a modular 4 operation among prime numbers as a second bidding coefficient, in case where each digit number of the binary number is 1, and
wherein the second bidding coefficient is larger than the first bidding coefficient.

44. The system of claim 41, wherein:
the client is also adapted to transmit the bidding coefficient to the successful bidding decider, and
the server is also adapted to verify whether or not the bidder transmitted an actual bidding price, by comparing the bidding function value transmitted from the client with the bidding function value generated by using the bidding coefficient transmitted from the client.

45. The system of claim 30, wherein the initial bidding price and the first bidding function value are encrypted using a public key infrastructure (PKI) for transmission between the client and the server.

46. A computer recordable recording medium having a program for executing the method of claim 1.
